(19) United States
(12) Patent Application Publication
(10) Pub. No.: US 2026/0297982 A1
(43) Pub. Date: Oct. 1, 2026

(54) INTERIOR LOCK UNIT FOR A DOOR LOCKSET ASSEMBLY

(71) Applicant: MASTER LOCK COMPANY LLC, Oak Creek, WI (US)

(72) Inventor: Wai P. Wong, Orange, CT (US)

(21) Appl. No.: 19/629,171

(22) Filed: Mar. 26, 2026

Related U.S. Application Data
(60) Provisional application No. 63/779,357, filed on Mar. 28, 2025.

(51) Int. Cl. E05B 63/14; E05B 3/00

(52) U.S. Cl. CPC E05B 63/143; E05B 3/00

(57) ABSTRACT

A lock unit for a door lockset assembly includes an escutcheon for mounting to a door. The escutcheon includes a tubular wall defining a handle passage extending from a front portion of the escutcheon to a rear portion of the escutcheon. A connector tube is installed in the handle passage, with a front end extending beyond the front portion of the escutcheon and a rear end extending beyond the rear portion of the escutcheon. A door handle is attached to the front end of the connector tube. A spindle guide is retained in the connector tube and defines a spindle bore extending to a rear portion of the spindle guide. A spindle is receivable in the spindle bore and includes a front portion secured in the spindle bore and a rear portion extending beyond the rear portion of the escutcheon for operative engagement with a latchbolt assembly of the door.

### CROSS-REFERENCE TO RELATED APPLICATION

This application claims priority to and all benefit of U.S. Provisional Patent Application Ser. No. 63/779,357, filed on Mar. 28, 2025, for INTERIOR LOCK UNIT FOR A DOOR LOCKSET ASSEMBLY, the entire disclosure of which is incorporated herein by reference.

### FIELD

The disclosed embodiments relate generally to door locksets and more particularly to interior door lock units to operate deadbolt and latchbolt mechanisms of an entry door.

### BACKGROUND

Some entry door locksets include both deadbolt mechanisms to secure a door against unauthorized entry and latchbolt mechanisms to retain the unlocked door in the closed position. Deadbolt locks are conventionally unlocked with a key or other valid credential used with an exterior lock unit of the lockset, such that an authorized user or building resident can enter or exit through the access point. Conventional deadbolt assemblies of such locks extend into an associated jamb adjacent the access point. Some deadbolt locks may be electro-mechanically actuated, for example, as initiated by an electronic user interface, such as a multi-button or touchscreen keypad, key card reader, biometric scanner (e.g., fingerprint, retina, facial recognition, voice recognition) or wireless transceiver for receiving an authorization signal. Conventional latchbolt assemblies include a spring biased latchbolt retractable during closing movement of the door by engagement with a strike plate of the door jamb, and extendable through an opening in the strike plate when the door is closed. The latchbolt may be lockable in the extended position as a secondary lock point or may be provided without a locking mechanism.

Some door locks, even those with an electronic user interface, include an interior lock unit with one or more mechanical actuating elements, such as a handle (e.g., knob or lever) or thumbturn to allow the user to physically retract the deadbolt and/or latchbolt from the door frame to thereby allow the door to open (e.g., by pivoting about one or more hinges). In some systems, an interior lock unit includes an interconnect mechanism providing for simultaneous retraction of both the latchbolt and the deadbolt by operation of a single actuating element (e.g., lever handle), for example, to facilitate exit from a locked building (e.g., in the event of an emergency). Such interconnect mechanisms, typically involving actuation of a deadbolt offset from the actuating element, may utilize gearing arrangements that may be susceptible to misalignment and/or jamming over time, for example, due to component wear and/or abuse.

### SUMMARY

According to an exemplary implementation of the present disclosure, a lock unit for a door lockset assembly includes an escutcheon for mounting to a door, with the escutcheon including a tubular wall defining a handle passage extending from a front portion of the escutcheon to a rear portion of the escutcheon. A connector tube is installed in the handle passage, with a front end extending beyond the front portion of the escutcheon and a rear end extending beyond the rear portion of the escutcheon. A door handle is attached to the front end of the connector tube. A spindle guide is retained in the connector tube and defines a spindle bore extending to a rear portion of the spindle guide. A spindle is receivable in the spindle bore and includes a front portion secured in the spindle bore and a rear portion extending beyond the rear portion of the escutcheon for operative engagement with a latchbolt assembly of the door.

According to another exemplary implementation of the present disclosure, a lock unit for a door lockset assembly includes an escutcheon for mounting to the door, with the escutcheon including a tubular wall defining a handle passage extending from a front portion of the escutcheon to a rear portion of the escutcheon. A connector tube is installed in the handle passage, with a front end extending beyond the front portion of the escutcheon and a rear end extending beyond the rear portion of the escutcheon. A door handle is attached to the front end of the connector tube. A spindle includes a front portion secured with the connector tube and a rear portion extending beyond the escutcheon for operative engagement with a latchbolt assembly of the door. A deadbolt shaft is assembled with the escutcheon and includes a rear portion extending beyond the escutcheon for operative engagement with a deadbolt assembly of the door. An interconnect assembly is assembled with the escutcheon and includes a cam element rotationally connected to the spindle for driving rotation of the deadbolt shaft from a locked position to an unlocked position when the spindle is rotated from the latching position to the releasing position. The rear end of the connector tube, a rear portion of the cam element, and the spindle extend through an opening in a rear wall assembled with the escutcheon. The rear portion of the cam element includes a flange portion axially captured axially captured beyond the rear wall.

According to another exemplary implementation of the present disclosure, a battery enclosure for an electromechanical device includes a housing member having a front wall portion extending between first and second side wall portions, with the housing member defining a battery cavity open to a cutout portion extending across the front wall portion and into the first and second side wall portions. A battery tray is secured to the housing member and retained within the battery cavity, with the battery tray defining one or more battery retaining recesses and carrying one or more pairs of conductive battery contacts. A battery cover having a front wall and first and second side walls defining a generally U-shaped cross section is releasably secured within the cutout portion of the housing member by a first spring tab configured to releasably engage the first side wall and a second spring tab configured to releasable engage the second side wall.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

Further advantages and benefits will become apparent to those skilled in the art after considering the following description and appended claims in conjunction with the accompanying drawings, in which:

FIG. 1A is a front perspective view of a door lockset system, in accordance with an exemplary aspect of the present disclosure;

FIG. 1B is a rear perspective view of the door lockset system of FIG. 1A;

FIG. 1C is a partially exploded perspective view of the door lockset system of FIG. 1A;

FIG. 1D is a front perspective view of the mounting plate of the interior lock unit of the door lockset system of FIG. 1A;

FIG. 2A is a front perspective view of the interior lock unit of the door lockset system of FIG. 1A;

FIG. 2B is a rear perspective view of the interior lock unit of FIG. 2A;

FIG. 2C is a partially exploded rear perspective view of the interior lock unit of the door lockset system of FIG. 1;

FIG. 2D is a partial cross-sectional view of the lower portion of the interior lock unit of FIG. 2A;

FIG. 2E is a rear perspective view of the lower portion of the interior lock unit of FIG. 2A, shown with the retaining rings removed;

FIG. 3 is an exploded perspective view of the door handle assembly of the interior lock unit of FIG. 2A;

FIG. 4A is a rear perspective view of the interlock and spindle assembly of the interior lock unit of FIG. 2A;

FIG. 4B is a front perspective view of the interlock and spindle assembly of FIG. 4A;

FIG. 4C is a front perspective view of the interlock and spindle assembly of FIG. 4A, with the base plate removed to illustrate additional features of the assembly;

FIG. 4D is a front perspective view of the butterfly cam of the interior lock unit of FIG. 2A;

FIG. 4E is a rear perspective view of the butterfly cam of the interior lock unit of FIG. 2A;

FIG. 5A is a front perspective view of the interior lock unit of FIG. 2A, shown with the battery cover removed;

FIG. 5B is a bottom cross-sectional view of the interior lock unit of FIG. 2A, illustrating features of the battery enclosure;

FIG. 5C is an enlarged partial bottom cross-sectional view of the interior lock unit of FIG. 2A, illustrating features of the battery enclosure;

FIG. 5D is a rear perspective view of the battery cover of the interior lock unit of FIG. 2A; and

FIG. 5E is a front perspective view of the battery tray of the interior lock unit of FIG. 2A.

### DETAILED DESCRIPTION

This Detailed Description merely describes exemplary embodiments and is not intended to limit the scope of the claims in any way. Indeed, the invention as claimed is broader than and unlimited by the described embodiments, and the terms used in the claims have their full ordinary meaning.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

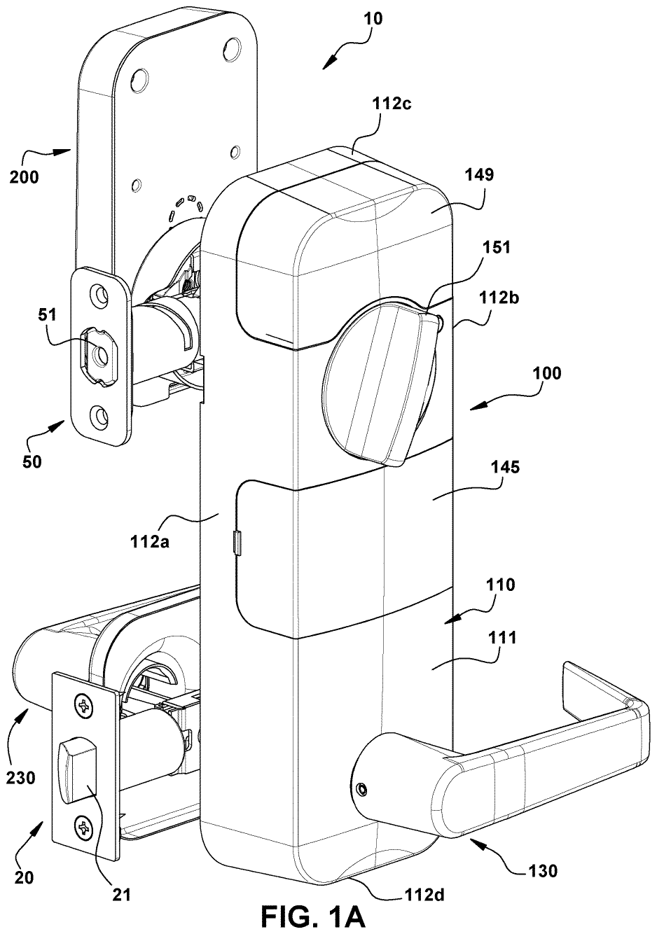

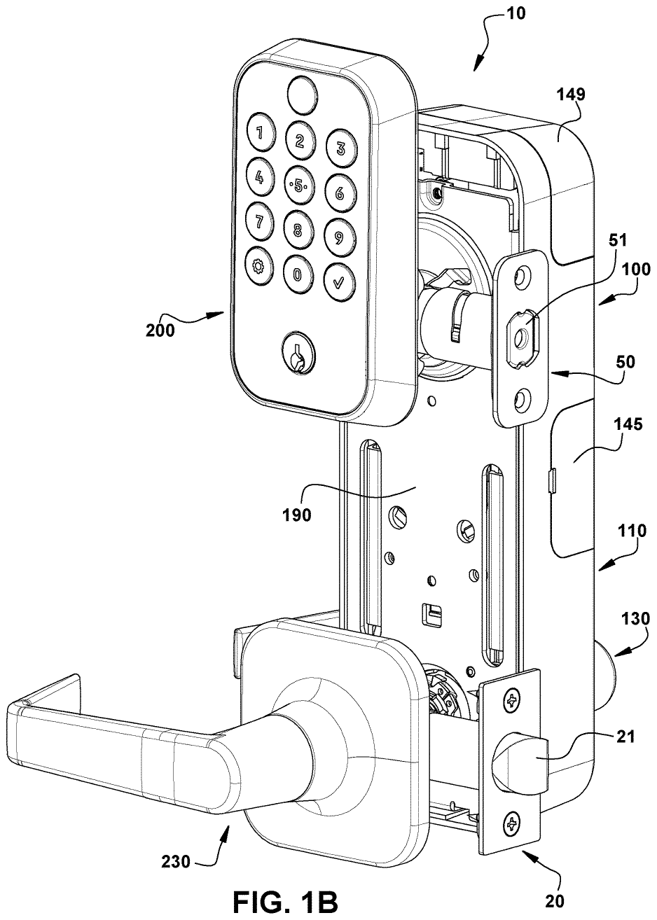

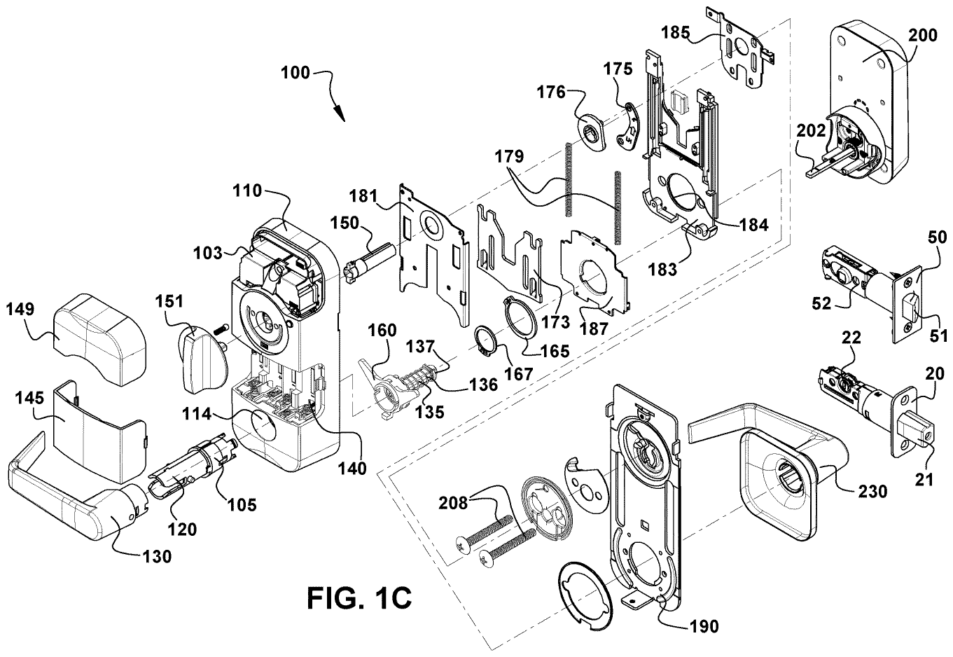

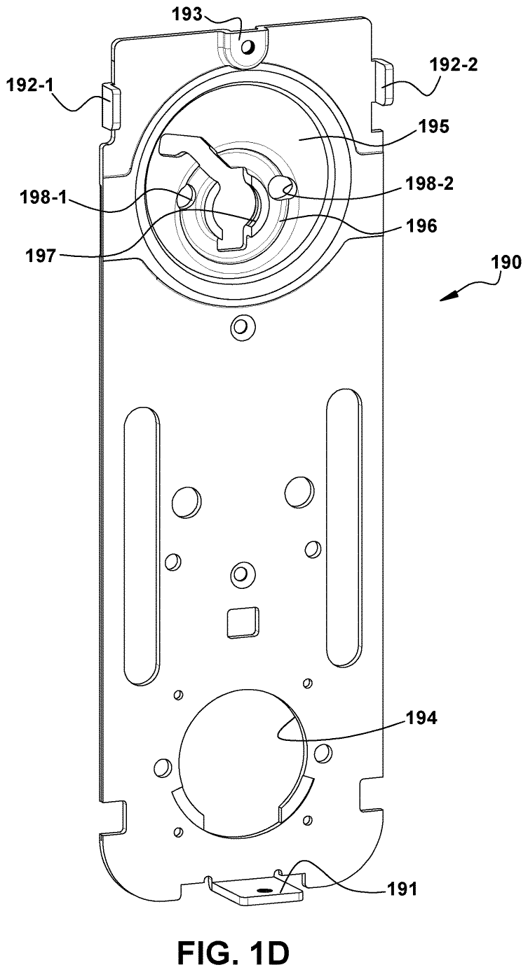

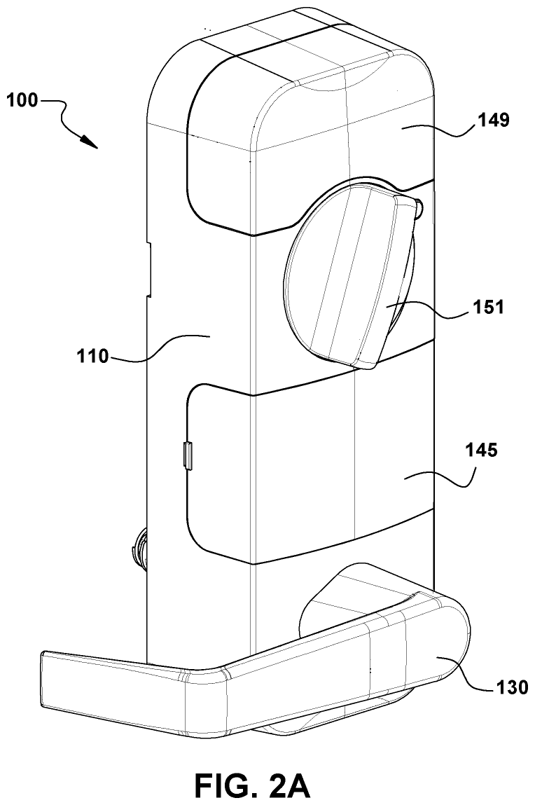

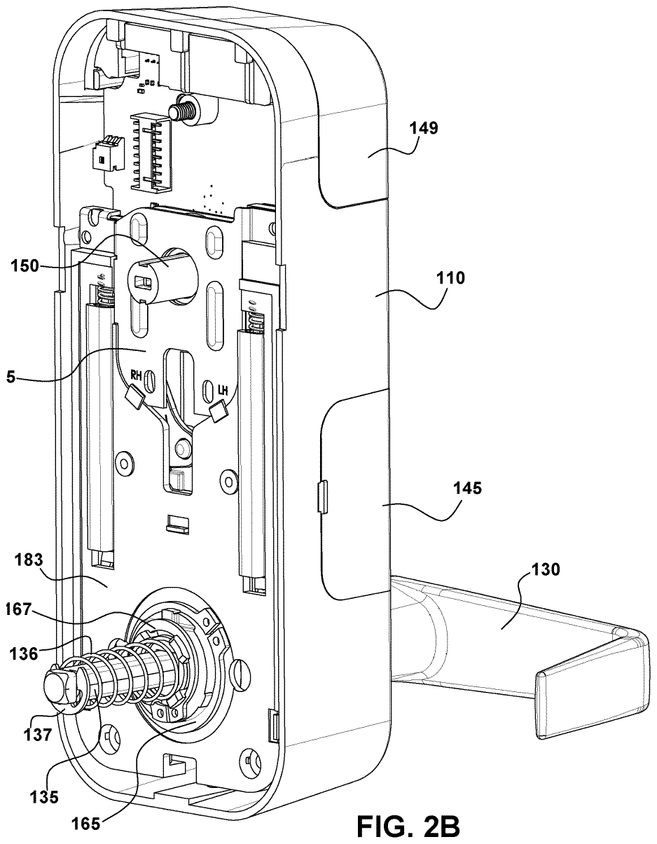

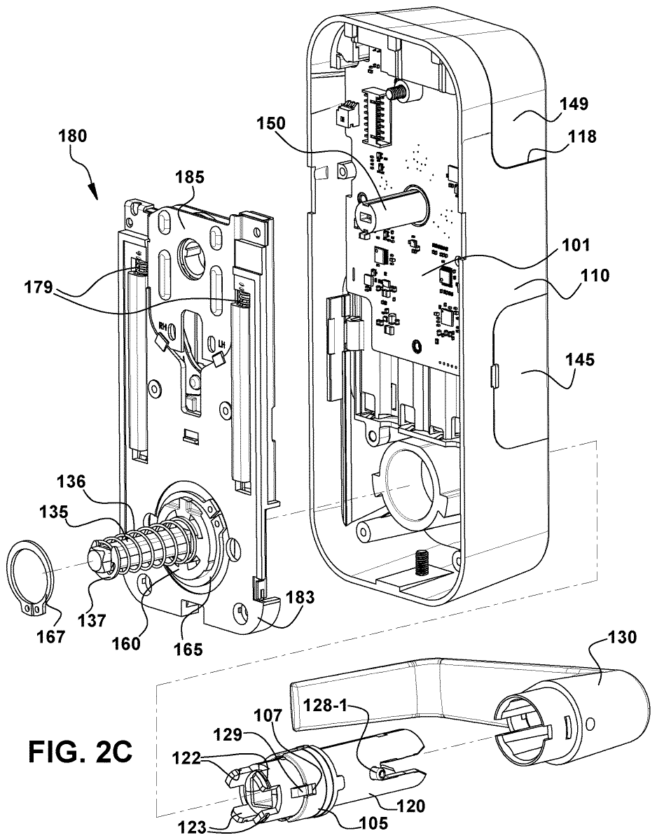

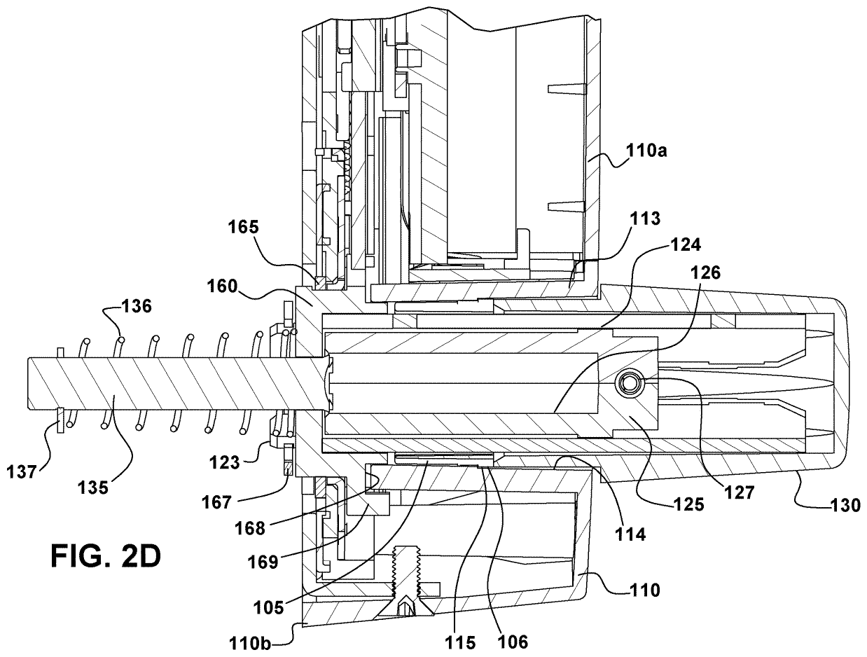

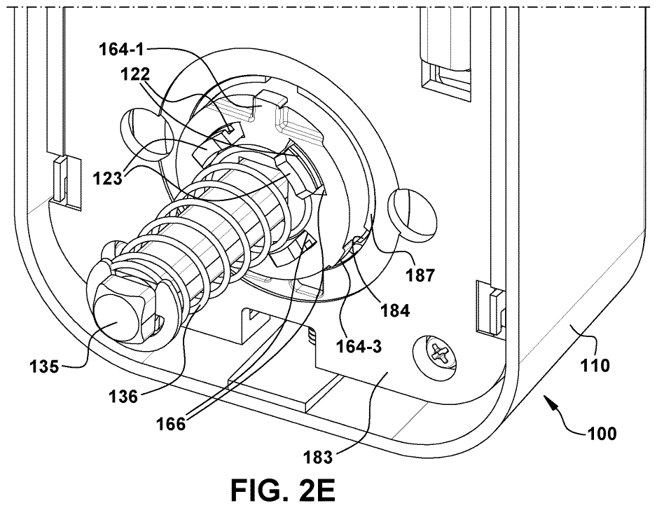

With reference to FIGS. 1A, 1B, and 1C, an exemplary entry door lockset 10 includes a latchbolt assembly 20 including a spring-biased latchbolt 21 extendable into latching engagement with a strike plate of a door jamb (not shown) and a latchbolt cam 22 rotatable to retract the latchbolt from the strike plate, and a deadbolt assembly 50 including a deadbolt cam 52 (which may interlock with a tailpiece 202 of the exterior lock unit 200, as shown) and a deadbolt 51 extendable into and retractable from a recess in the door jamb by rotation of the deadbolt cam. An interior lock unit 100 (also shown in FIGS. 2A-2D) is securable to the interior side of the entry door for operation of the latchbolt and deadbolt assemblies 20, 50. An exterior lock unit 200 is securable to the exterior side of the entry door for operation of the deadbolt assembly 50, and an exterior lever handle assembly 230 is securable to the exterior side of the entry door for operation of the latchbolt assembly 20. In some implementations (not shown), an entry door lockset may include an exterior lock unit that includes both a deadbolt operating mechanism and a latchbolt actuating element (e.g., lever handle). In still other implementations (not shown), an entry door lockset may additionally or alternatively include two interior lock units, with a first interior lock unit configured to operate the latchbolt and a second interior lock unit configured to operate the deadbolt.

In the illustrated embodiment, the interior lock unit 100 includes an escutcheon or housing 110 mountable to the interior side of an entry door (e.g., by mounting plate 190). The exemplary escutcheon 110 includes exterior front and side walls 111, 112a-d enclosing the latchbolt and deadbolt actuating mechanisms, and a tubular wall 113 defining a handle passage 114 extending from a front portion 110a of the escutcheon to a rear portion 110b of the escutcheon.

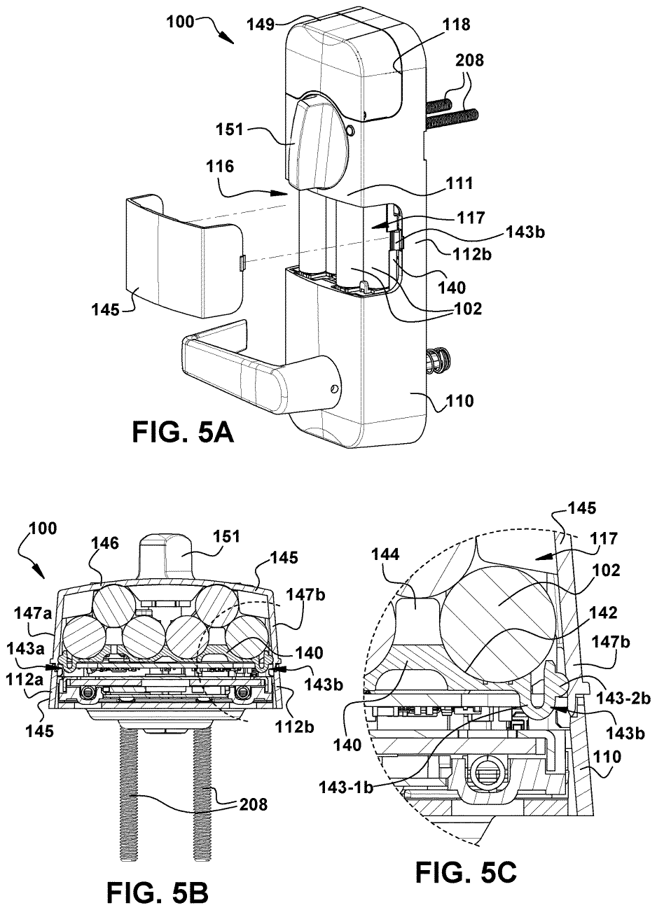

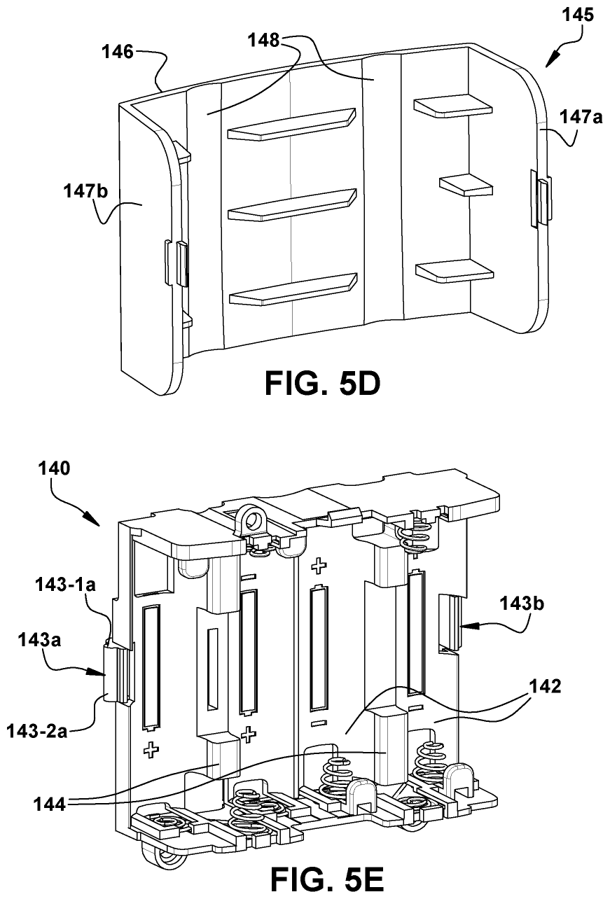

As shown in FIG. 1D, the exemplary mounting plate 190 includes a lower tab 191 extending into the escutcheon 110 and securable to a bottom wall of the escutcheon by a screw or other fastener, upper tabs 192-1, 192-2 extending into the escutcheon for aligning the escutcheon on the mounting plate, and an apertured top portion 193 for fastening a top portion of the escutcheon to the mounting plate. A lower cutout 194 is provided for alignment with the latchbolt cavity of the door (not shown), and a rearward embossed upper portion 195 is sized and shaped to be seated in a circular deadbolt cavity of the door (not shown). As shown the embossed upper portion 195 may include a central portion 196 defining an aperture 197 sized to receive the deadbolt shaft 150, and mounting holes 198-1, 198-2 receiving mounting fasteners (e.g., bolts 208, shown in FIGS. 5A, 5B) for securing the interior lock unit 100 to the exterior lock unit 200. The central portion 196 may be formed by a secondary embossment, for example, to provide increased rigidity of the mounting plate 190 (e.g., to withstand a pulling force applied to the external lock unit 200).

A connector tube or rollback 120 is installed in the handle passage 114, with a front end 120a extending beyond the front portion 110a of the escutcheon 110, and a rear end 120b extending beyond the rear portion 110b of the escutcheon. A bushing 105 may be installed in the handle passage 114, for example, to provide axial and radial support for the connector tube 120. In the illustrated embodiment, the bushing 105 includes an outer lip portion 106 that engages an inner ledge portion 115 of the handle passage 114 (FIG. 2D), and forward notch portions 107 that receive outer radial tabs 129 of the connector tube 120.

A door handle (e.g., lever handle) 130 is rotationally fixed to the front end 120a of the connector tube 120, and a spindle 135 is rotationally fixed with the rear end 120b of the connector tube and extends beyond the rear portion 110b of the escutcheon 110 for operative engagement with the latchbolt cam 22, such that rotation of the door handle rotates the spindle to rotate the latchbolt cam, thereby retracting the latchbolt 21. As shown, the rear portion of the lever handle 130 may include a tubular cuff 132 that extends into the handle passage 114 of the escutcheon 110, adjacent to the front end of the bushing 105.

The spindle 135 is retractable into the connector tube 120 for axial adjustment of the extension of the spindle beyond the escutcheon, for example, to account for positional variability of the latchbolt cam 22 within the entry door. The spindle 135 may be rearwardly biased (e.g., by spring 136 compressed between the cam element 160, described below, and a retaining ring 137 secured to the rear end of the spindle) to extend rearward into operative engagement with the latchbolt cam 22. According to an aspect of the present disclosure, to prevent misalignment of the spindle 135 when retracted into the connector tube 120, the connector tube may be provided with a spindle bore sized and shaped to closely receive the spindle when the spindle is at least partially retracted into the connector tube, thereby limiting lateral/radial movement of the spindle within the connector tube and preventing misalignment/cocking and potential jamming of the retracted spindle. The spindle and spindle bore may be shaped to facilitate co-rotation; for example, the spindle may have a generally square-shaped cross-section, and the spindle more may have a corresponding square-shaped cross-section sized to closely receive the spindle for rotationally fixed co-rotation.

While the spindle bore may be integrated into the connector tube component, in some implementations, a spindle guide defining the spindle bore may be installed in the connector tube. A variety of spindle guides may be provided with a variety of arrangements for rotationally fixing the spindle guide within a connector tube of a lock unit. In the illustrated embodiment, a spindle guide 124 includes first and second body halves 125-1, 125-2 each defining a portion of a spindle bore 126. The spindle guide body halves 125-1, 125-2 may, for example, be formed from plastic (e.g., as injection molded parts), and may be configured to be press fit together (e.g., by pin and socket connections) to form the spindle guide body 125. The first and second body halves may be identical, for example, to reduce tooling and inventory costs.

To axially and rotationally secure the spindle guide 124 within the connector tube 120, the spindle guide may be provided with one or more retractable pins that extend from the spindle guide body and through corresponding apertures in the connector tube. In the illustrated embodiment, the spindle guide body 125 defines a pin retaining passage 127 retaining first and second pins 128-1, 128-2 and a spring 128-3 configured to bias the pins outward, in opposite directions, from the spindle guide body and through apertures 121-1, 121-2 in the connector tube 120.

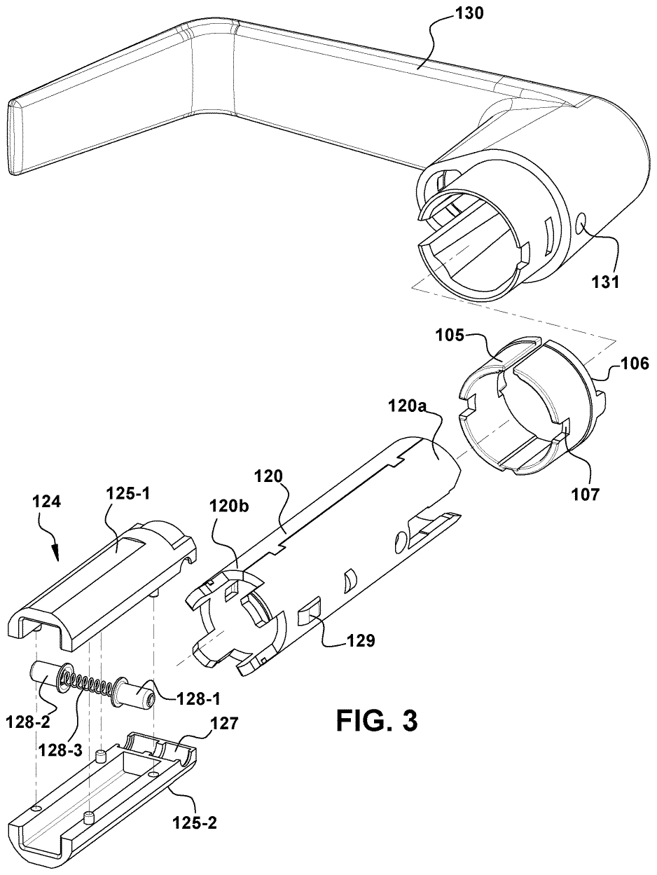

In some implementations, the pin(s) securing the spindle guide within the connector tube may additionally secure the door handle to the front end of the connector tube. In the illustrated embodiment, the door handle 130 includes an aperture 131 (FIG. 3) that receives an end portion (extending outward of the connector tube 120) of an aligned one of the spring biased pins 128-1, 128-2 to releasably attach the door handle to the front end 120a of the connector tube 120.

In the illustrated embodiment, the interior lock unit 100 includes a deadbolt actuating element (e.g., thumbturn) 151 rotationally connected with a deadbolt shaft 150 extending beyond the rear portion 110b of the escutcheon 110 for operative engagement with the deadbolt cam 52, such that rotation of the thumbturn rotates the deadbolt shaft to rotate the deadbolt cam, thereby retracting (when rotated in a first direction) or extending (when rotated in an opposite second direction) the deadbolt 51.

As described above, an interior lock unit may, but need not, include an interconnect assembly, disposed within the escutcheon, for operatively connecting the spindle with the deadbolt shaft, such that rotation of the door handle (or other latchbolt actuating element) and connected spindle from a latching position to a releasing position drives rotation of the deadbolt shaft from a locked position (i.e. with deadbolt extended) to an unlocked position (i.e. with deadbolt retracted).

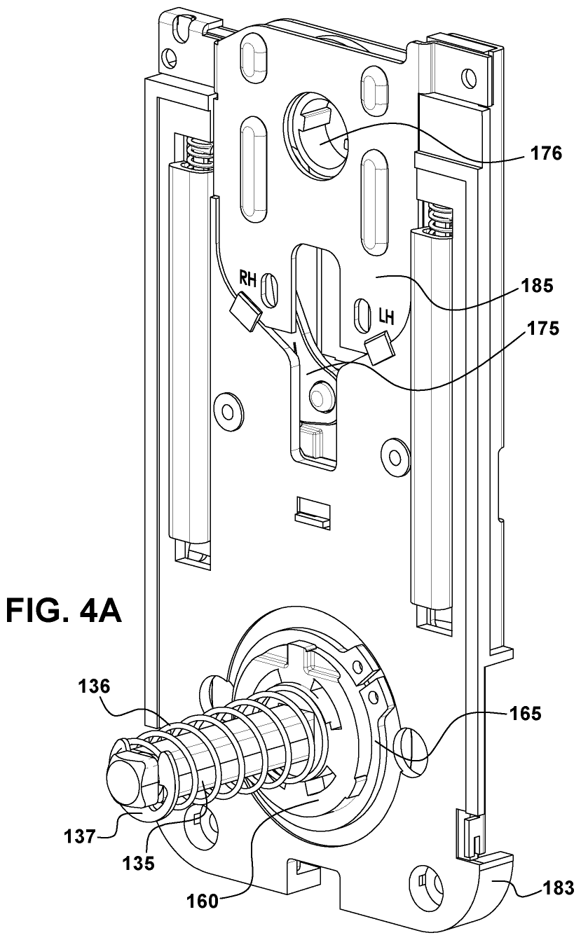

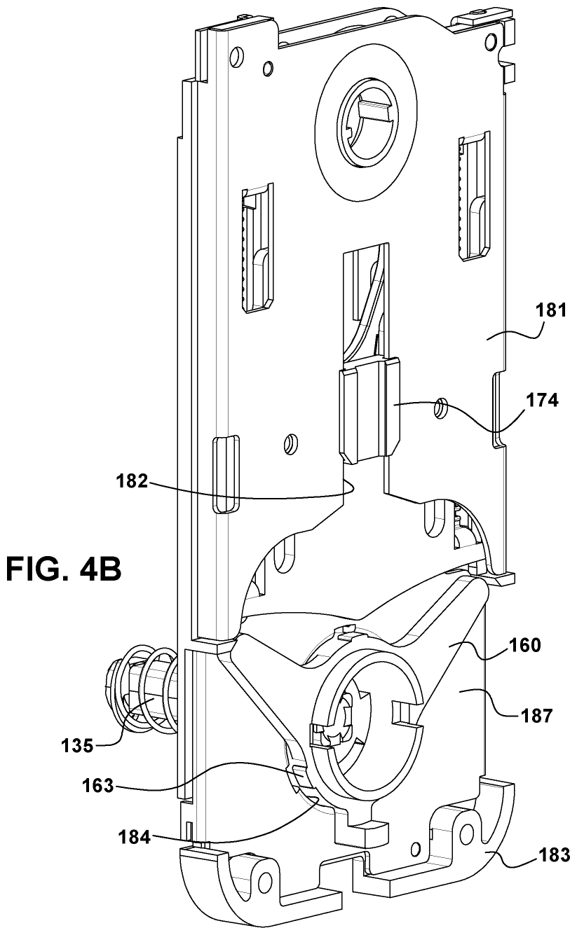

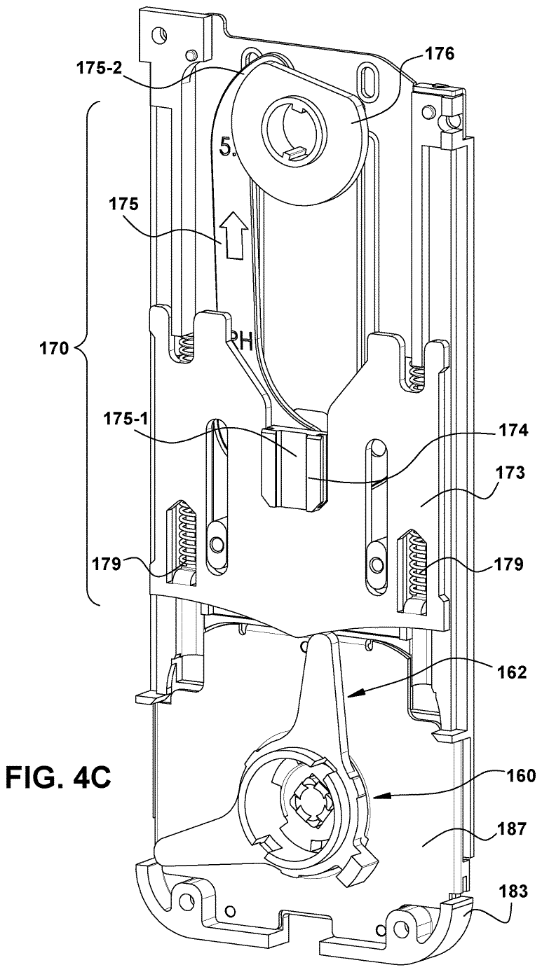

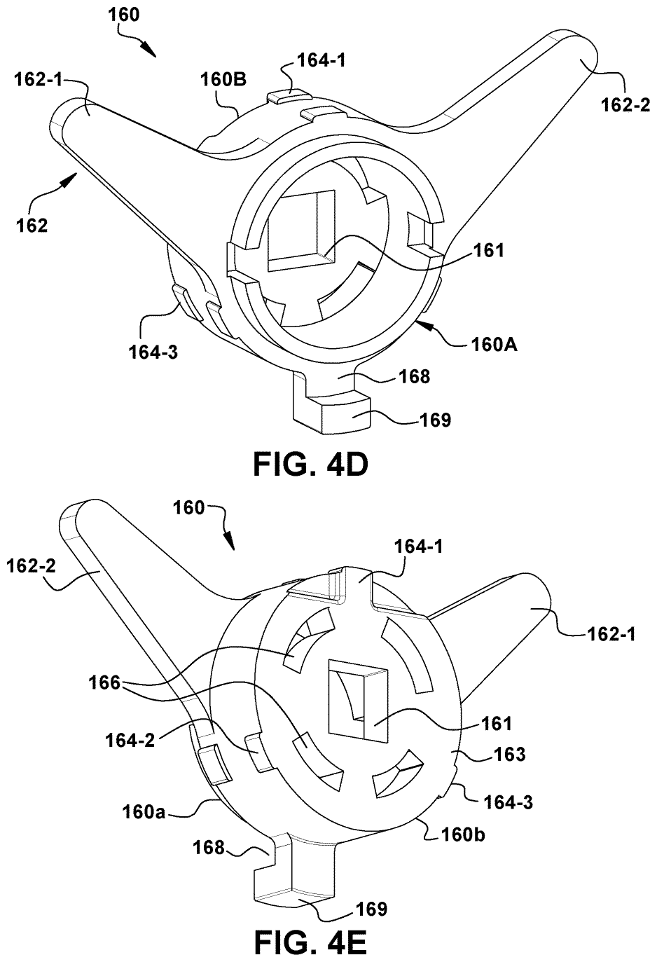

A variety of suitable interconnect assemblies may be utilized. As one example, an interconnect assembly may include a cam element rotationally fixed to the spindle, with one or more camming projections or arm portions that engage a linkage subassembly for rotating a deadbolt camming portion rotationally fixed to the deadbolt shaft. In the illustrated embodiment, a cam element (e.g., butterfly cam, as shown in FIGS. 4D-E) 160 includes an aperture 161 sized and shaped (e.g., generally square shaped, as shown) to closely receive the spindle 135, for co-rotation of the cam element with the spindle. A front portion 160a of the cam element 160 includes a camming portion 162 for driving a linkage subassembly 170 (FIG. 4C). While many different linkage subassemblies may be used, in the illustrated assembly, the linkage subassembly includes a slider 173 engaged by the camming portion 162 of the cam element 160, a slide block 174 in abutment with the slider, a link member 175 having a first end 175-1 pivotably connected to the slide block and a second end 175-2 pivotably connected to a shaft cam 176, which is rotationally fixed to the deadbolt shaft 150.

When the spindle 135 is rotated, by rotation of the lever handle 130, from the latching position to the releasing position, the cam element 160 rotates to move the camming portion 162 against the slider 173 to move the slider and the slide block 174 from a first, lower position, to a second, higher position. Movement of the slide block 174 moves the first end 175-1 of the link member 175, driving movement of the second end 175-2 of the link member to rotate the shaft cam 176 and the deadbolt shaft 150.

The slider 173 may be spring biased (e.g., by springs 179) toward the lower first position, such that when the lever handle 130 is released, the slider returns to the first position, thereby rotating the cam element 160, spindle 135, connector tube 120, and lever handle 130 from the releasing position to the latching position, while the slide block 174 remains in the higher second position, maintaining the shaft cam 176 and the deadbolt shaft 150 in the unlocked position.

In the illustrated embodiment, the camming portion 162 includes two camming arms 162-1, 162-2 each engageable with the slider 173, such that rotation of the lever handle 130 and spindle 135 in either direction (i.e., clockwise or counterclockwise) causes one of the camming arms to push the slider from the first position to the second position to drive rotation of the shaft cam 176 and the deadbolt shaft 150 from the locked position to the unlocked position. In other implementations, the interconnect arrangement may be configured to only unlock the deadbolt when the handle and spindle are rotated in one of the two directions (e.g., by providing the cam element with only one camming arm).

To properly position and align the linkage subassembly within the lock unit, the linkage subassembly components may be retained in a modular interconnect housing that may be mounted to or otherwise assembled within the escutcheon. In the illustrated embodiment, the linkage module enclosure 180 includes a base plate 181 fastened to an interior wall of the escutcheon 110 and defining a track 182 (FIG. 4B) receiving and supporting sliding movement of the slide block 174, a module housing 183 mounted over the base plate to capture the slider 173 and the slider biasing springs 179, a link cover plate 185 assembled to the housing to cover and provide access to the link member 175, and a cover shield 187 secured to a front surface of the module housing 183 to provide a bearing surface for the camming portion 162 of the cam element 160.

Because engagement of the cam element camming portion 162 and the slider 173 is limited to relatively thin abutting edges, it may be desirable to closely control the axial position of the cam element camming portion within the lock unit. According to an aspect of the present disclosure, to properly position and align the cam element with respect to the linkage subassembly, a rear portion of the cam element may be axially captured rearward of a rear wall of the lock unit, for example, between first and second retaining rings or other positioning features that may be precisely axially positioned by portions of the lock unit.

In the illustrated embodiment, the cam element rear portion 160b includes a cylindrical hub portion 163 received through an opening 184 in the module housing 183 and cover shield 187 (FIG. 4B). The hub portion 163 includes one or more flange projections 164-1, 164-2, 164-3 sized and positioned to receive a first retaining ring 165 between the flange projections and the rear wall of the module housing 183. A ring of one or more slots 166 receive tang extensions 123 of the connector tube rear end 120b (FIG. 2E). The tang extensions 123 define outer grooves 122 arranged to receive a second retaining ring 167, such that the flange projections 164-1, 164-2, 164-3 are axially captured between the first and second retaining rings 165, 167, and the axial position of the cam element 160 is closely controlled with respect to the linkage subassembly 170 and the connector tube 120. As shown, the tang extensions may additionally support and retain the front portion of the spindle biasing spring 136.

As shown, the front portion 160a of the cam element 160 may include an outer radial notch 168 (e.g., defined by a radially extending leg portion 169, as shown) that receives a rear edge of the tubular wall 113 of the escutcheon 110 (FIG. 2D), for example, for radial, rotational alignment of the cam element during actuation.

As shown, the exterior actuating elements of an interconnected latchbolt and deadbolt lockset, as described herein, may be provided in separate units, for example, a deadbolt actuating exterior lock unit 200, and a latchbolt actuating lever handle assembly 230, as shown. Such an arrangement may provide a greater adaptability of the type of access restricted external actuating mechanisms used to operate the deadbolt, including, for example, mechanical actuating mechanisms such as key operated lock cylinder arrangements, mechanical push button arrangements, and mechanical combination dial arrangements, and electromechanical arrangements such as electronic push button/touchpad arrangements, key card reader arrangements, biometric scanner (e.g., fingerprint, retina, facial recognition, voice recognition) arrangements, and wireless transceiver initiated arrangements.

While such exterior actuating arrangements may include operating mechanisms (e.g., manually driven handle, thumbturn, or ring, or electrically powered motor) for actuating the deadbolt, in other embodiments, the exterior actuating arrangement merely communicates authorization signals to the interior lock unit (e.g., to a processor via wired or wireless communication) for authentication and actuation within the interior lock unit. In such arrangements, the interior lock unit may be provided with a clutch assembly (e.g., utilizing one or more gears and/or cams) that connects an exterior actuator (e.g., electrically powered motor) to the deadbolt cam for operation actuation of the deadbolt only when authorized entry has been authenticated. Exemplary clutch arrangements for door lock assemblies are disclosed in co-owned U.S. Pat. No. 8,141,400 and U.S. Patent Application Pub. No. 2024/0035307, the entire disclosures of which are incorporated herein by reference.

To deter attacks on an electromechanical locking mechanism for a door lock, certain elements of the electromechanical locking arrangement may be provided in the interior lock unit, with electrical connections (e.g., wiring) passing between the external and internal lock units through the deadbolt cavity in the door. As one example, the interior lock unit may be provided with a battery enclosure for retaining one or more batteries for powering the exterior lock unit.

In the illustrated embodiment, the escutcheon 110 of the interior door lock unit 100 includes a cutout portion 116 extending across the front wall portion 111 and into the side wall portions 112a-b to expose a battery cavity 117 within the escutcheon. A battery tray 140 is secured to the escutcheon 110 (e.g., by direct attachment to the powered circuit board 101, FIG. 2C) and retained within the battery cavity 117. The battery tray 140 defines one or more battery retaining recesses 141 and carries one or more pairs of conductive battery contacts (not shown) for connection with batteries 102 installed in the battery retaining recesses. In the illustrated embodiment, the tray provides a plurality of battery retaining recesses, with a rear layer of battery retaining recesses 141b and a front layer of battery retaining recesses 141a, staggered to reduce the depth of the battery cavity. As shown, the rear layer of recesses may be at least partially defined by a contoured wall 142 shaped to support a plurality of cylindrical batteries 102, and the front layer of one or more battery retaining recesses is at least partially defined by one or more divider walls 144 separating two or more of the battery recesses of the rear layer of battery recesses, each of the at least one divider wall being configured to support a corresponding cylindrical battery disposed in the front layer recesses.

A battery cover 145 is provided for installation in the cutout portion 116 of the escutcheon 110 to enclose the battery cavity 117. In the illustrated example, the battery cover includes a front wall 146 and first and second side walls 147a, 147b defining a generally U-shaped cross section for covering the cutout portion 116 of the escutcheon 110. To further support the batteries in the desired positions within the recesses, the battery cover front wall 146 may be provided with contoured channels 148 shaped to support batteries retained in the front layer of battery retaining recesses.

A variety of arrangements may be used to releasably attach the battery cover 145 to the escutcheon. In the illustrated embodiment, the first side wall 147a of the battery cover 145 releasably engages a first spring tab 143a and the second side wall 147b releasably engages a second spring tab 143b, such that the battery cover is attachable to the escutcheon 110 by pushing the battery cover against the escutcheon in a direction perpendicular to the front wall 111 of the escutcheon. The battery cover 145 may likewise be detachable from the escutcheon 110 by simply grasping the side walls 147a, 147b of the battery cover and pulling the battery cover away from the escutcheon (although in some implementations, a screwdriver or other prying tool may be used to detach the battery cover side walls from the spring tabs 143a, 143b).

In some arrangements, the battery cover engaging spring tabs are formed with or attached to the escutcheon. In the illustrated embodiment, the spring tabs 143a, 143b are integrally formed with the sides of the battery tray 140. As shown, the spring tabs 143-1, 143-2 may include a proximal portion 143-1a, 143-2a extending away from the escutcheon front wall 111 and a distal portion 143-1b, 143-2b extending toward the escutcheon front wall to form a U-shaped cross section of the spring tab. This U-shaped cross section allows for flexing of the spring tab when providing the battery tray 140 in a relatively rigid material (e.g., zinc or aluminum casting).

Other electronic components may additionally or alternatively be retained in the interior lock unit. In the illustrated embodiment, an electronics cover 149 is releasably securable within an upper cutout 118 of the escutcheon 110, to provide access to one or more electronics modules (e.g., RFID or Wi-Fi wireless communication module, memory storage, microprocessor) 103 retained within an electronics cavity 119 of the escutcheon.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A lock unit for a door lockset assembly, the lock unit comprising:
an escutcheon for mounting to a door, the escutcheon including a tubular wall defining a handle passage extending from a front portion of the escutcheon to a rear portion of the escutcheon;
a connector tube installed in the handle passage, with a front end extending beyond the front portion of the escutcheon and a rear end extending beyond the rear portion of the escutcheon;
a door handle attached to the front end of the connector tube;
a spindle guide retained in the connector tube and defining a spindle bore extending to a rear portion of the spindle guide; and
a spindle receivable in the spindle bore and including a front portion secured in the spindle bore and a rear portion extending beyond the rear portion of the escutcheon for operative engagement with a latchbolt assembly of the door.

2. The lock unit of claim 1, wherein the spindle guide comprises first and second body halves each defining a portion of the spindle bore.

3. The lock unit of claim 1, wherein the spindle guide includes at least one retractable pin extending through a corresponding aperture in the connector tube to secure the spindle guide in the connector tube.

4. The lock unit of claim 3, wherein the at least one retractable pin extends through an aperture in the door handle to secure the door handle on the front end of the connector tube.

5. The lock unit of claim 3, wherein the at least one retractable pin comprises first and second retractable pins extending from the spindle guide in opposite directions.

6. The lock unit of claim 5, further comprising a spring element disposed within the spindle guide for outward biasing of the first and second retractable pins.

7. The lock unit of claim 1, wherein each of the spindle bore and the spindle has a substantially square cross-section.

8. The lock unit of claim 1, further comprising a deadbolt shaft assembled with the escutcheon and including a rear portion extending beyond the escutcheon for operative engagement with a deadbolt assembly of the door, and an interconnect assembly assembled with the escutcheon, wherein the interconnect assembly connects the spindle with the deadbolt shaft, such that rotation of the spindle from a latching position to a releasing position drives rotation of the deadbolt shaft from a locked position to an unlocked position.

9. The lock unit of claim 8, wherein the interconnect assembly includes a cam element rotationally connected to the spindle, a slider engageable with the cam element for sliding movement from a first position to a second position when the spindle is rotated from the latching position to the releasing position, and a linking element engageable with the slider for rotation of the deadbolt shaft from the locked position to the unlocked position when the slider is moved from the first position to the second position.

10.-17. (canceled)

18. A lock unit for a door lockset assembly, the lock unit comprising:
an escutcheon for mounting to the door, the escutcheon including a tubular wall defining a handle passage extending from a front portion of the escutcheon to a rear portion of the escutcheon;
a connector tube installed in the handle passage, with a front end extending beyond the front portion of the escutcheon and a rear end extending beyond the rear portion of the escutcheon;
a door handle attached to the front end of the connector tube;
a spindle including a front portion secured with the connector tube and a rear portion extending beyond the escutcheon for operative engagement with a latchbolt assembly of the door;
a deadbolt shaft assembled with the escutcheon and including a rear portion extending beyond the escutcheon for operative engagement with a deadbolt assembly of the door; and
an interconnect assembly assembled with the escutcheon, the interconnect assembly comprising a cam element rotationally connected to the spindle for driving rotation of the deadbolt shaft from a locked position to an unlocked position when the spindle is rotated from the latching position to the releasing position;
wherein the rear end of the connector tube, a rear portion of the cam element, and the spindle extend through an opening in a rear wall assembled with the escutcheon; and
wherein the rear portion of the cam element includes a flange portion axially captured beyond the rear wall.

19. The lock unit of claim 18, wherein the rear portion of the cam element is axially captured between a first retaining ring assembled with the cam element and a second retaining ring assembled with the rear end of the connector tube.

20. The lock unit of claim 18, wherein the cam element includes a notch receiving a rear portion of the tubular wall, for guiding the cam element on the tubular wall when the spindle is rotated between the latching position and the releasing position.

21. The lock unit of claim 18, further comprising a spring element disposed between the cam element and the rear portion of the spindle, for biasing the spindle rearward from the connector tube.

22. The lock unit of claim 18, further comprising a retaining ring assembled with the rear portion of the spindle to retain the spring element on the spindle.

23. The lock unit of claim 18, wherein the rear end of the connector tube defines an outer peripheral groove receiving the second retaining ring.

24. The lock unit of claim 18, wherein the cam element includes one or more slots receiving the rear portion of the connector tube therethrough.

25. The lock unit of claim 18, wherein the interconnect assembly further includes a slider engageable with the cam element for sliding movement from a first position to a second position when the spindle is rotated from the latching position to the releasing position, and a linking element engageable with the slider for rotation of the deadbolt shaft from the locked position to the unlocked position when the slider is moved from the first position to the second position.

26.-30. (canceled)

31. A battery enclosure for an electromechanical device, the battery enclosure comprising:
a housing member including a front wall portion extending between first and second side wall portions, the housing member defining a battery cavity open to a cutout portion extending across the front wall portion and into the first and second side wall portions;
a battery tray secured to the housing member and retained within the battery cavity, the battery tray defining one or more battery retaining recesses and carrying one or more pairs of conductive battery contacts; and
a battery cover having a front wall and first and second side walls defining a generally U-shaped cross section, the battery cover being releasably securable within the cutout portion of the housing member by a first spring tab configured to releasably engage the first side wall and a second spring tab configured to releasable engage the second side wall.

32. The battery enclosure of claim 31, wherein the first and second spring tabs are integrally formed with the battery tray.

33. The battery enclosure of claim 32, wherein the first and second spring tabs each have a proximal portion extending away from the housing member front wall portion and a distal portion extending toward the housing member front wall portion to form a U-shaped cross section.

34.-39. (canceled)
